(19) United States
(12) Patent Application Publication
(10) Pub. No.: US 2017/0193335 A1
(43) Pub. Date: Jul. 6, 2017

(54) METHOD FOR DATA ENCODING AND ACCURATE PREDICTIONS THROUGH CONVOLUTIONAL NETWORKS FOR ACTUAL ENTERPRISE CHALLENGES

(71) Applicant: Wise Athena Inc., San Francisco, CA (US)

(72) Inventors: Ana Montoro, San Fransisco, CA (US); Federico Castanedo, San Fransisco, CA (US); Jaime Zaratiegui, San Fransisco, CA (US); Alfonso Vazquez, San Fransisco, CA (US)

(21) Appl. No.: 15/350,602

(22) Filed: Nov. 14, 2016

Related U.S. Application Data
(60) Provisional application No. 62/254,844, filed on Nov. 13, 2015.

(51) Int. Cl. G06K 9/62; G06N 3/04; G06N 3/08

(52) U.S. Cl. CPC G06K 9/6267; G06N 3/08; G06N 3/04; G06K 9/4652

(57) ABSTRACT

Disclosed is a method of classifying non-visual data. The method may include a stage of receiving each of a plurality of non-visual data and a plurality of classifications. Further, the method may include a stage of transforming the plurality of non-visual data into a plurality of visual images. Additionally, the method may include a stage of generating an image classifier based on the plurality of visual images and the plurality of classifications. Further, the method may include a stage of receiving an un-classified non-visual data. Furthermore, the method may include a stage of transforming the un-classified non-visual data into an un-classified visual image. Additionally, the method may include a stage of assigning a classification to the un-classified non-visual data based on classifying the un-classified visual image using the image classifier.

### RELATED APPLICATION

Under provisions of 35 U.S.C. §119(e), the Applicant claims the benefit of U.S. provisional application No. 62/254,844, filed Nov. 13, 2015, which is incorporated herein by reference, including all filed appendices. It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to data processing and artificial intelligence. More specifically, the disclosure relates to methods and systems for encoding non-visual data as images and extracting data, information, and knowledge from the images using machine learning, such as for example, deep learning.

### BACKGROUND

Advances in the field of data processing have enabled reduction in manual efforts. However, in several cases, due to complexities associated with data, substantial manual efforts continue to be required in carrying out processing of the data.

For example, classifying data associated with human behavior is tremendously complex in several instances. Accordingly, when large quantities of such data are to be classified, manual efforts are employed for constructing characteristic features associated with each class. This process is commonly known as feature engineering. Subsequently, machine learning may be used to generate classification models based on the characteristic features. Further, unclassified data may then be automatically classified based on the classification models.

However, the process of feature engineering is laborious, time intensive and requires deep knowledge of the domain corresponding to the data. As a result, useful insights that may be gleaned from vast quantities of data remain inaccessible. For example, based on human behavior data, such as Call Detail Records (CDRs), several predictions of future user behavior, such as churn, may be made. However, automatically processing huge volumes of human behavior data continues to remain a challenge, particularly owing to the manual efforts of identifying features that correlate with a specific behavior, such as churn.

Therefore, there is a need for methods and systems for facilitating classification of data while minimizing manual efforts.

### Brief Overview

A method and system may be provided for facilitating the transformation of non-visual data to visual data to address prediction problems. The prediction problems may include but not be limited to classification problems and regression problems. The term classifying, as used herein, may refer to, but not be limited to, the extraction of information/data/knowledge. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

An object of the present disclosure may be to facilitate classification of non-visual data using image classification techniques. Accordingly, the nonvisual data may be classified into one or more classes of a plurality of classes. Further, an object of the present disclosure may be to minimize and/or eliminate manual efforts in the process of identifying characteristic features corresponding to the plurality of classes. Furthermore, an object of the present disclosure may be to minimize and/or eliminate feature engineering. Yet further, an object of the present disclosure may be to classify an unclassified nonvisual data based on image based machine learning.

Accordingly, disclosed herein is a computer implemented method of classifying non-visual data. The computer implemented method may include a stage of transforming the non-visual data into at least one visual image. Further, the computer may include a stage of assigning at least one classification to the at least one visual image based on at least one feature associated with the at least one visual image.

Further, also disclosed herein is a computer implemented method of facilitating classification of non-visual data. The computer implemented method may include a stage of receiving each of a plurality of non-visual data and a plurality of classifications corresponding to the plurality of non-visual data. Further, each non-visual data of the plurality of non-visual data may be associated with at least one classification of the plurality of classifications. Additionally, the computer implemented method may include a stage of transforming the plurality of non-visual data into a plurality of visual images. Furthermore, the computer implemented method may include a stage of analyzing the plurality of visual images and the plurality of classifications. Additionally, the computer implemented may include a stage of determining at least one feature associated with a visual image based on the analyzing. Further, the at least one feature may be characteristic of a classification of the plurality of classifications.

Additionally, also disclosed herein is a computer implemented method of classifying non-visual data based on an image classifier. The computer implemented method may include a strep of receiving each of a plurality of non-visual data and a plurality of classifications corresponding to the plurality of non-visual data. Further, the computer implemented method may include a stage of transforming the plurality of non-visual data into a plurality of visual images. Additionally, the computer implemented method may include a stage of generating the image classifier based on the plurality of visual images and the plurality of classifications. Further, the computer implemented method may include a stage of receiving an un-classified non-visual data. Furthermore, the computer implemented method may include a stage of transforming the un-classified non-visual data into an un-classified visual image. Additionally, the computer implemented method may include a stage of assigning a classification to the un-classified non-visual data based on classifying the un-classified visual image using the image classifier.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a block diagram of an operating environment consistent with the present disclosure.

FIG. 2 illustrates a flowchart of computer implemented method of classifying a non-visual data in accordance with some embodiments.

FIG. 3 illustrates a flowchart of computer implemented method of facilitating classification of a non-visual data in accordance with some embodiments.

FIG. 4 illustrates a flowchart of computer implemented method of classifying a non-visual data in accordance with some embodiments.

FIG. 5 illustrates a visual image corresponding to a non-visual data in accordance with some embodiments.

FIG. 6 illustrates a flowchart of a method in which raw data is encoded into images which are then used as input to a deep learning predictor model, according to some embodiments.

FIG. 7 illustrates an encoding example for a churn prediction problem, in accordance with some embodiments.

FIG. 8 illustrates an encoding example for a product demand prediction in a retail company, in accordance with some embodiments.

FIG. 9 illustrates a flowchart of an encoding process, in accordance with some embodiments.

FIG. 10 illustrates an encoding example of a nine day period for a single customer with a high degree of activity in three categories. Start of the week white mark can be observed in the middle of the image. Time increases from left to right.

FIG. 11 illustrates customer labeling according to respective top-up activity in the 28 consecutive days following to the training data shown in the image. Churners are defined as those who did not have any top-up activity in this period.

FIG. 12 illustrates an architecture of a network for classifying non-visual data comprising two stages, in accordance with some embodiments. The first stage consists of an alternating combination of convolutional and max pooling layers applied in order to extract low-level features. The second stage consists of three fully connected layers ending in a soft-max activation function.

FIG. 13 illustrates validation metrics of the best model of each algorithm class for churn prediction problem. It can be noticed that at least some methods disclosed herein (referred to as WiseNets in figure) outperform all the other models in every indicator considered.

FIG. 14 illustrates a block diagram of a non-visual data classification system including computing device, in accordance with an embodiment.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of stages of various processes or methods that are described herein are illustrative and not restrictive. Accordingly, it should be understood that, although stages of various processes or methods may be shown and described as being in a sequence or temporal order, the stages of any such processes or methods are not limited to being carried out in any particular sequence or order, absent an indication otherwise. Indeed, the stages in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “stage for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of classifying non-visual data pertaining to user behavior, embodiments of the present disclosure are not limited to use only in this context. For example, the non-visual data classification system may be used to classify non-visual data pertaining to business processes, retail chains, sensor events, medical conditions etc.

### I. Platform Overview

Consistent with embodiments of the present disclosure, non-visual data classification platform (also referred to herein as “platform”) may be provided. This overview is provided to introduce a selection of concepts in a simplified form that are further described below. This overview is not intended to identify key features or essential features of the claimed subject matter. Nor is this overview intended to be used to limit the claimed subject matter's scope. The non-visual data classification platform may be used by individuals or companies to classify non-visual data such as, for example user behavior data. One instance of such user behavior data may pertain to activity of users of a telecommunication service. Accordingly, the user behavior data may include, for example, Call Detail Records (CDRs) and top-up or balance replenishment actions. Although embodiments of the present disclosure are described with reference to data classification, it should be understood that the various embodiments may be expanded to perform other types of data processing.

The platform may be embodied as, at least in part, a software application. The configuration of the software application and associated servers will be provided below.

The platform is configured to receive raw data and encode it into images specifically crafted for applying structured data from, for example, a real business problem. These images are then inputted into a deep learning model that learns features from the images in order to make predictions. The platform may be trained in a training phase prior to entering a prediction phase.

Encoding raw data into images enables leveraging the advantages of deep learning architectures from computer vision field to learn high-level features and identify patterns in non-visual data pertaining to, for example, any business problem.

One of the strengths of deep learning predictive algorithms is the ability of discovering hierarchical feature representations from large amount of input data by the composition of multiple non-linear transformations. Therefore, the traditional and time consuming stage of building hand-crafted features can be avoided by using deep learning and convolutional networks (ConvNets) in the specific case of images.

Feature engineering is the process of transforming raw data, which may non-visual, into features that better represent the underlying problem to the predictive models. The features in the non-visual data may directly influence the predictive models and the results that can be achieved. Feature engineering is difficult, time consuming and requires domain knowledge but it can be avoided by using deep learning algorithms and convolutional networks (ConvNets) in accordance with the methods disclosed herein. Deep learning is a facet of machine learning that involves the use of neural networks in order to discover high-level features from large amount of input data. Whereas the superiority of deep learning and ConvNets in particular against traditional machine learning models is clear when dealing with noisy unstructured data (e.g. images), their application to structured input data has been less explored. ConvNets using structured data as input images outperforms traditional supervised classifiers with hand-crafted features, with no need to perform the labor-intensive stage of feature engineering.

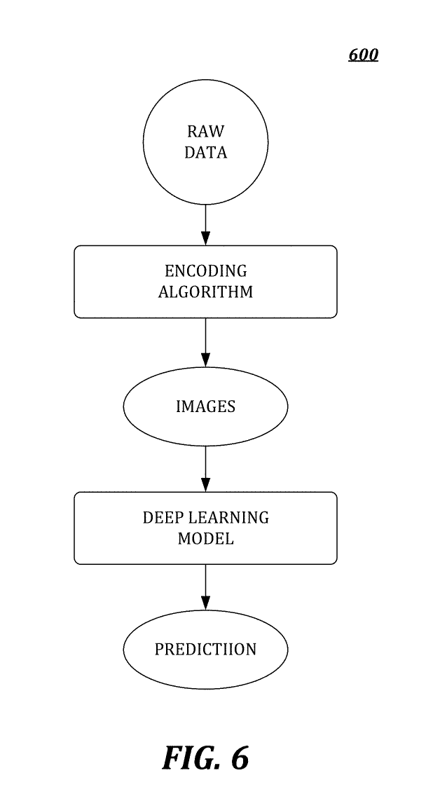

The methods disclosed herein, also called as WiseNet™, consist of a novel encoding method that transforms raw data, which may be non-visual, into images which form the input of a Deep Learning prediction model as illustrated in FIG. 6.

These methods can be applied to several business problems from very different nature. For example, customers and hardware segmentation and classification, product pricing and demand prediction, spam detection, recommendation systems for advertisements or purchase recommendations, preventing fraud and data breaches, financials and economics decisions, insurance or medical diagnosis and so on.

WiseNet methods can be used for supervised learning, when we have labeled training data, for unsupervised learning, when we have only a set of unlabeled training examples and for reinforcement learning, a kind or learning algorithm that takes the view of an agent that tries to maximize the reward that it is receiving from making decisions.

These methods learn patterns from images to solve classification problems, when the output variable takes class labels such as, for example, fraud detection, churn prediction or market segmentation problems, as well as regression problems, when the output variable takes continuous values, for example demand prediction or seeing how a stock price is affected by changes in interest rates.

When dealing with raw structured data we can find different kind of variables, numerical (discrete or continuous), categorical or ordinal variables. Accordingly, these methods can encode any of these kind of variables and represent them as an image.

### A. Image Encoding

The encoding stage can be seen as a transformation from the input space of the data to a specific training domain. Input data of any business problem can be encoded as images for being recognized and classified. The method can encode images into different color models: RGB (red, green and blue), CMY (cyan, magenta and yellow), HSI (Hue, Saturation and Intensity) or YIQ (luminance, inphase and quadrature).

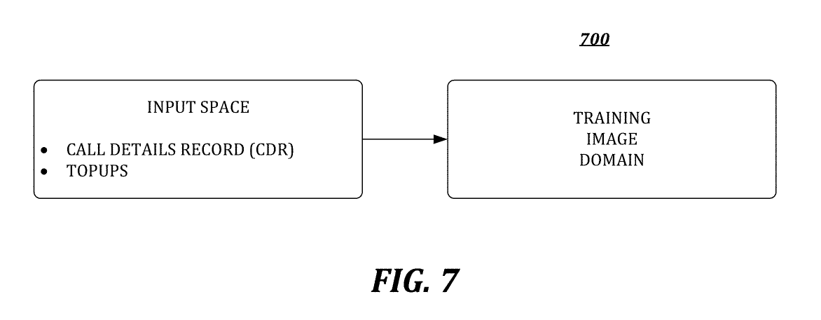

For example, in a telecommunication environment, several data sources are available from the customer behavior point of view, such as Call Detail Records (CDRs), balance replenishment events (top-ups), geographical activity, social network activity, data-usage behavior, promotions/marketing campaigns, to name a few. In order to come up with a general model the platform goal is to avoid specific details and therefore use the least and rawest data as possible. WiseNet methods can encode data of each costumer into an image that represents the costumer behavior in order to predict if a costumer is going to make churn as illustrated in FIG. 7.

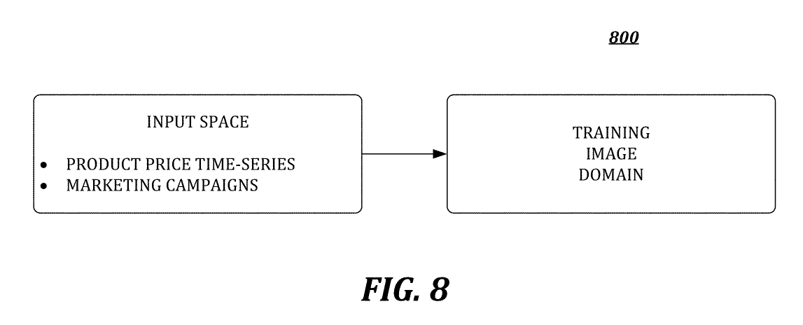

Considering the problem of a product demand forecasting in a retail company in order to optimize pricing decisions, prices time-series of the product and data of marketing campaigns applied may be taken into account and encoded into an image to predict the demand for a future promotional cycle as illustrated in FIG. 8.

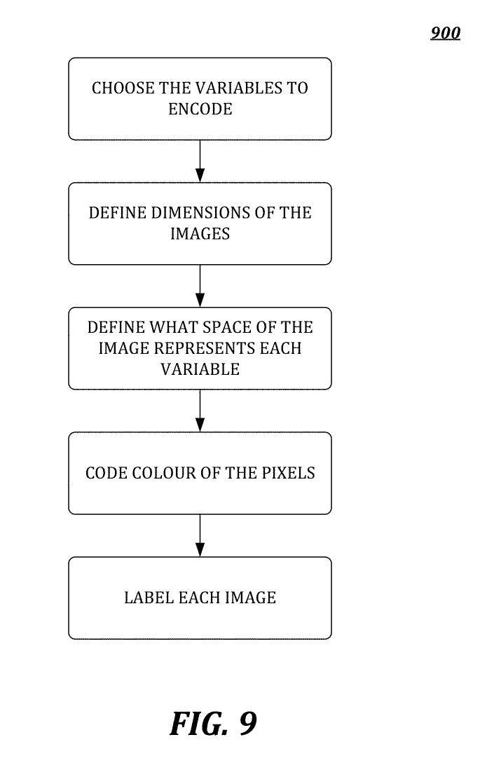

The stages of the encoding process can be seen in FIG. 9. First of all, the variables to be encoded into images may be chosen to solve the problem. After that the dimensions of the images may be defined and how the variables are going to be placed in the image may be determined. The next stage is the color codification of the pixels considering the values of the variables to be represented. At the end, every image may be labeled with the target value that needs to be predicted.

For the specific business problem of predicting customer churn in telecommunication, the methods can use categorical, numerical and ordinal variables from customer activity data and Call Detail Records (CDRs). Predicting churn of prepaid telecommunication customers is a complex task since there is no specific termination date of their contract. Under these circumstances, deactivation occurs after a period of time during which the customer did not perform a balance replenishment. It can be further observed that, once the customer has decided or is in the process of deciding whether to transition, the customer's phone usage patterns may start to change.

One example of the encoding algorithm for churn prediction uses the Call Detail Records (CDRs) and top-ups data. The Call Detail Records provide log information with details about each call made by the costumer. This information includes the cell tower where the call was made, the number originating the call, when the call was made (time-stamp), the duration of the call, the destination number, and the service identification (incoming/outgoing call or SMS). Top-ups data describe a history of balance replenishment events for each costumer, basically the costumer id, the time-stamp and the amount spent.

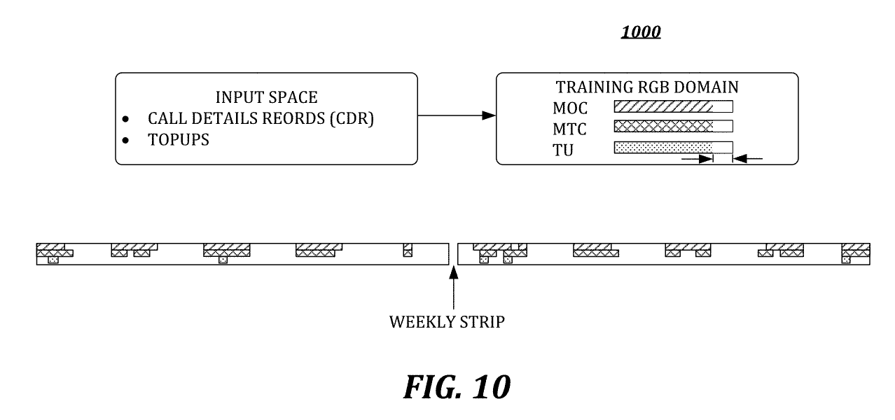

Accordingly, customer data may be encoded into a linear time representation. Hence, time is linearly mapped into the x-axis of the image. The y-axis is reserved for each one of the data sources, i.e. outgoing call activity (MOC), incoming calls (MTC) and top-ups as illustrated in FIG. 10. The image width spans the whole period of time considered in the training stage, which is exactly four weeks or 28 continuous days of user activity. Furthermore, each day may be split into 12 equally sized time slices and, as a result, each of these slices, i.e. pixels, spans a period of two hours. Therefore, the total image width and height in pixels is 336×3.

The value or intensity of each pixel in the image is proportional to the customer's activity in each of the three possible categories taking into account that 120 minutes is the maximum activity that can be registered by a pixel. Due to the fact that most variance is found closest to zero activity, we scale the pixel's base value I according to the following power law: I(k, tₙ)=Iₖᵣᵥ^{α} where tₙ is the n time slice and k is a categorical label that indicates either outgoing or incoming calls and α is chosen to be equal to 1/7 in order to better exploit variance in those pixels that have the lowest base values.

In an instance, the RGB space may be chosen and each of the RGB channels may be used to represent separately each of the three categories MOC (red), MTC (green) and top-ups (blue), as shown in FIG. 10.

For the top-up activity channel, a different way of representing the input data may be chosen. In this case, the balance top-up activity is predominantly done by redeeming coupons of discrete value and seldom by doing a bank transfer of a non-preset quantity. Consequently, the pixel values will be mostly discrete. In this case, the pixel intensity will be linearly proportional to the amount replenished but will saturate at a certain point. Accordingly, a saturation value may be set to the maximum value of a single prepaid coupon which is available for purchase. A single customer could redeem several of these maximum face value coupons in the same two hour period but the value of that pixel in the blue channel will not be affected as it will already be saturated.

Further, a single extra feature may be added to the images, that is a white 1×3 pixel mark at each point where local time is Monday at 00:00 hours. In some instances, this may be done at the expense of all activity data at that point as the white vertical strip deletes any previous value present at that point. The purpose of this strip is identifying the weekly periodicity inherent to calendar days besides any other recurring activity that the user could have as shown in FIG. 10.

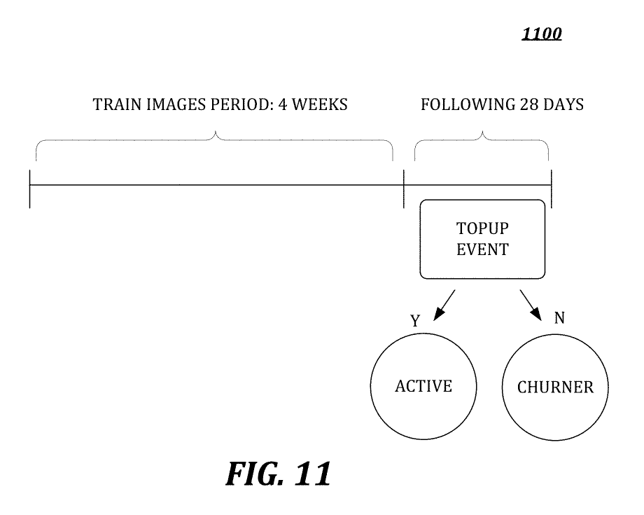

Each of the images is labeled according to the user top-up activity in the 28 consecutive days following the training data shown in the image. Churners are defined as those who did not have any top-up activity in this period and therefore, their corresponding images are labeled as 1 as illustrated in FIG. 11.

### B. Network Architecture

Deep learning is a branch of machine learning based on a set of algorithms that attempt to model high level features in data by multiple linear and non-linear transformations. Further, deep learning involves learning of multiple levels of representation and abstraction that help to make sense of data such as images, sound, and text.

WiseNet methods use encoded images as an input to any deep neural network which can have different architectures as Deep Belief Network (DBN), Autoencoders, Denoising Autoencoders, Convolutional Neural Networks (inspired by the visual system's structure), Convolutional Deep Belief Networks, Boltzmann Machines or Restricted Boltzman Machines.

The process of designing the network architecture involve the setting of the hyperparameters of the network which are variables set before actually optimizing the model's parameters. Setting the values of hyperparameters can be seen as model selection and the optimal values can be different for every business problem.

Deep neural networks can have many hyperparameters, including those which specify the structure of the network itself and those which determine how the network is trained. Some of that hyperparameters are Learning Rate, Loss function, Mini-batch Size, Number of Training Iterations, Momentum, Number of Hidden Units, Weight Decay, Activation Sparsity and Weight Initialization.

As an example of one WiseNet architecture and hyperparameters, the architecture applied to the churn prediction problem is described. ConvNets may be selected due to their ability to generalize to new samples and to perform feature learning. ConvNets have a specialized connectivity structure which exploits the strong spatial correlation exhibited in the customer behavior artificial images. Another reason for using convolutions is that the patterns may be shifted around and it would be desirable to detect this based on the position in the image.

Once features are learned using ConvNets, they are passed to a fully connected neural network which combines them in order to classify the input image into one specific class. For the application to churn prediction, images represent customers' behavior and the target class indicates if they are active or inactive customers (churners). Further, pooling layers may be used. ConvNets with pooling layers have some translation invariance built into their architecture. A pooling layer summarizes the information of the convolution units in a smaller number of units. A unit in a pooling layer receives input from a small neighborhood of convolution units in the layer below. Pooling layers can be divided into sum, average or max pooling. Further, max-pooling layers may be used, which means that the strongest convolutional filter response in the small region is passed on to the next layer.

These networks are remarkably sensitive to the initialization and the activation functions. Regarding activation functions, parametric rectifier linear units (PReLU) may be used. This type of activation function simplifies back-propagation, makes the learning phase faster and avoids saturation issues.

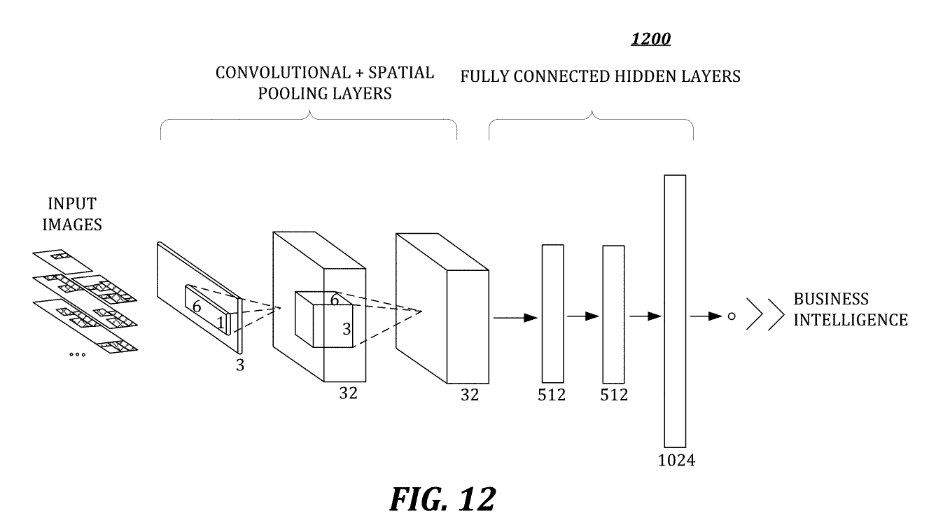

The design of the architecture of the network can be split into two stages or modules as shown in FIG. 12. In the first stage, convolutional and spatial pooling layers are applied sequentially taking as inputs the set of 336×3 RGB images. In the second stage, a series of fully connected hidden layers are used with the objective of exploiting the features extracted in the first stage.

The convolution filters used in the ConvNet are relatively small. In the first hidden layer, a rectangular 6×1 kernel with a stride of 1 may be used. In this stage, using a 1-pixel high filter, extraction may be performed of features which are dependent only on each of the rows of the images, i.e. the three different activity categories will not be mixed in this operation. After the second convolution layer, the data from the three rows of the image may be mixed as a 6×3 filter is used. The width of the convolution layers is also quite small, i.e. 32 channels wide.

### C. Performance Evaluation

Evaluation of WiseNet methods after the training phase over images for churn prediction problem was performed. In order to select the best model in the training phase we took the one with the minimum log-loss in the test dataset (0.4273). By following this strategy, we expect to choose the least biased model and therefore the best one at generalizing.

The performance on the validation dataset of our main indicator (the AUC) is 0.8787, which can be considered generally as a good result for a binary classifier.

In order to compare our best WiseNet model for churn prediction with other machine learning techniques we used the same artificial images as comma-separated value (CSV) files. The information contained in the RGB channels was flattened into a single value per pixel and stored into CSV file. To maintain the information at the start-of-the-week mark, we added a new variable in the CSV which fills in this gap. This variable indicates the offset, in pixels, at which the random 4-week sample has been cropped. As a result, each customer was described by a feature vector of 1009 dimensions plus one extra column containing the class label.

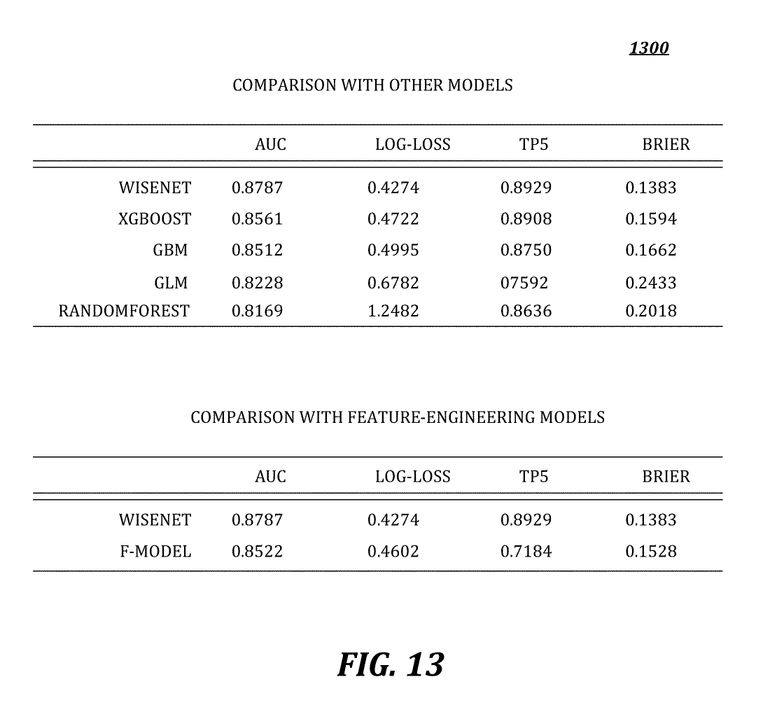

We considered the performance of four well-known machine learning algorithms compared to the best performing WiseNet model: randomForests, generalized linear models (GLM), generalized boosted machines (GBM) and extreme gradient boosting (xgboost). FIG. 13 illustrates the performance comparison for all models ranked by AUC in decreasing order from top to bottom. The optimal set of hyper-parameters was determined using the test dataset and optimizing the log-loss. Looking at the results, the WiseNet methods outperforms all the other models in every metric studied. Therefore, we can deduce that, under the conditions here reviewed, WiseNet methods can extract a higher amount of information and learn specific feature representations.

In order to demonstrate the power of WiseNet methods, we did a performance comparison between one of our in-house models which makes extensive use of feature engineering and WiseNet. These features, developed and fine tuned during months of work, condense our knowledge of this telecommunications particular market and its situation.

The in-house model has been trained with the same set of customers as previous models. It even includes new sources of data not used in the WiseNet methods, such as the geographical location of customers, use of other mobile services, categorical variables and social relationships with other customers. Another significant difference with the WiseNet model is that the training dataset size of the feature-engineering model is larger but the same validation dataset has been used nonetheless.

The WiseNet model applied to churn prediction problem outperforms the one using feature engineering in all the metrics considered as shown in FIG. 13.

### II. Platform Configuration

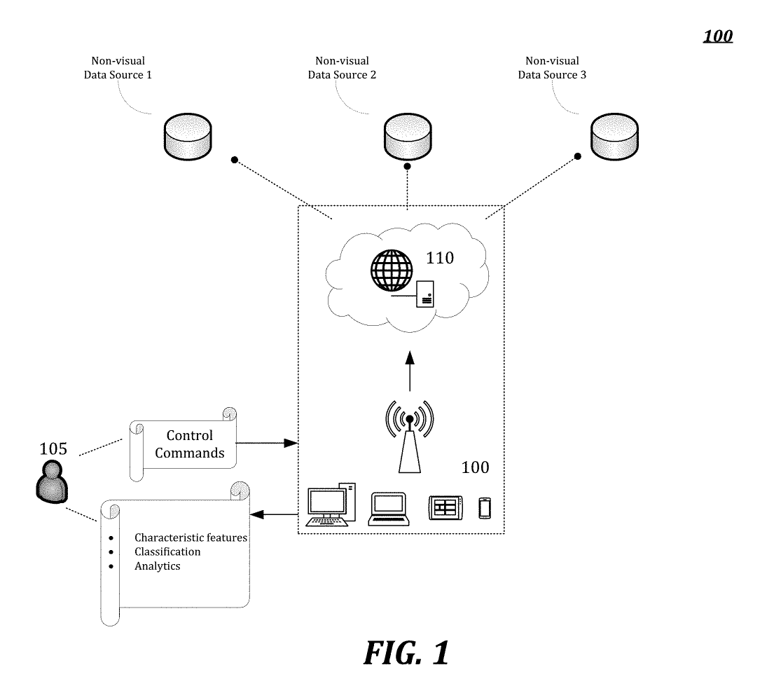

FIG. 1 is an illustration of a platform consistent with various embodiments of the present disclosure. By way of non-limiting example, a non-visual data classification platform 100 may be hosted on a centralized server 110, such as, for example, a cloud computing service. The centralized server may communicate with other networks that have applicable data, such as, for example, non-visual data sources 1-3 which may provide data such as Call Detail Records (CDRs), Top-up data and so on. A user 105 may access platform 100 through a software application. The software application may be embodied as, for example, but not be limited to, a website, a web application, a desktop application, and a mobile application compatible with a computing device 1400. One possible embodiment of the software application may be provided by OpenText™ Analytics Suite of products and services. Accordingly, the user may provide control commands in order to perform classification of non-visual data, such as for example, data representing user behavior of users of a telecommunications service. In response, the platform may generate one or more outputs including, for example, characteristic features of the non-visual data, classification of the non-visual data, analytics corresponding to the non-visual data and so on.

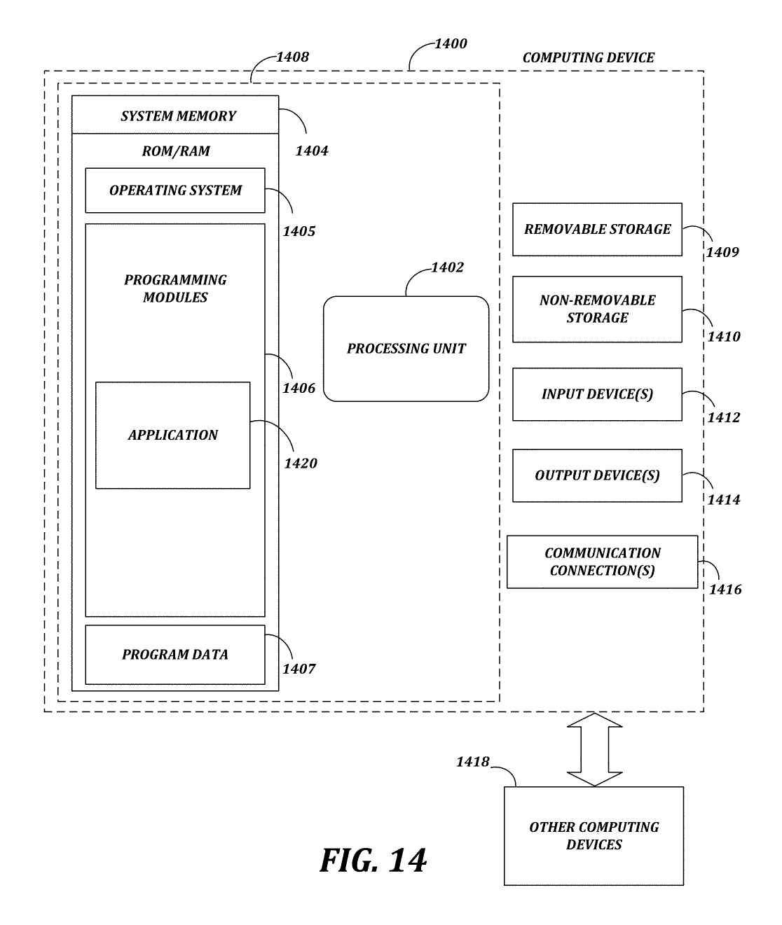

As will be detailed with reference to FIG. 14 below, the computing device through which the platform may be accessed may comprise, but not be limited to, for example, a desktop computer, laptop, a tablet, or mobile telecommunications device. As will be detailed with reference to FIG. 14 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### III. Platform Operation

Although methods 200, 300, 400, 600 and 900 have been described to be performed by platform 100, it should be understood that computing device 1400 may be used to perform the various stages of methods 200, 300, 400, 600 and 900. Furthermore, in some embodiments, different operations may be performed by different networked elements in operative communication with computing device 1400. For example, server 110 may be employed in the performance of some or all of the stages in methods 200, 300, 400, 600 and 900. Moreover, server 110 may be configured much like computing device 1400.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of methods 200, 300, 400, 600 and 900 will be described in greater detail below.

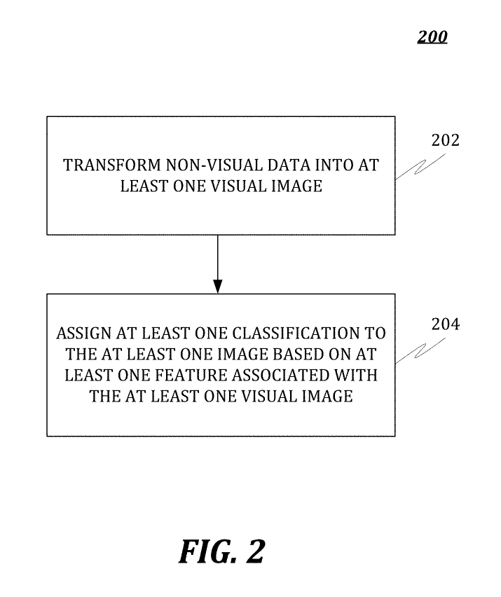

FIG. 2 is a flow chart of a method 200 for classifying non-visual data using, for example, platform 100 in accordance with various embodiments. Method 200 may be implemented using a computing device 1400 as described in more detail below with respect to FIG. 14.

The computer implemented method 200 of classifying non-visual data may include a stage 202 of transforming the non-visual data into at least one visual image. In some embodiments, the non-visual data may include a plurality of data elements, such as for example, but not limited to, variable-value pairs. Further, integrity of the non-visual data may be independent of a spatial arrangement of the plurality of data elements on a surface, such as for example, an active surface of a display device. In other words, irrespective of how the plurality of data elements may be spatially arranged, the integrity of the non-visual data may not be affected. Accordingly, the non-visual data may maintain representation of intended information for any arbitrary spatial arrangement of the plurality of data elements. In some embodiments, the non-visual data may include a plurality of data elements. Further, integrity of the non-visual data may be independent of a plurality of spatial relationships amongst the plurality of data elements.

In some embodiments, the non-visual data may include a plurality of data elements.

Further, each of the plurality of data elements may be not associated with a predetermined spatial location on a surface. In contrast, a visual data which is configured to be displayable on a display device in an established form comprises a predetermined spatial location (i.e. a coordinate on a display screen or a printing surface) corresponding to a data element of the visual data. However, the plurality of data elements comprised in the non-visual data is not associated with such spatial coordinates.

In some embodiments, the non-visual data may include a plurality of variables and a plurality of values corresponding to the plurality of variables. Further, each of the plurality of variables may be independent of a characteristic of a travelling wave. Further, the characteristic of the travelling wave may include one or more of an intensity, a frequency and a polarization. In other words, the plurality of variables may not be related to characteristics such as shape, texture etc. that are captured based on reflection of travelling waves. For instance, a visual data comprising two dimensional representation of a physical object may be generated by receiving light waves reflected by the physical object. Accordingly, each data element of the visual data is indicative of a characteristic of the light waves, such as for example, intensity and/or frequency. In contrast, the non-visual data may not be related to any such characteristic of a travelling wave.

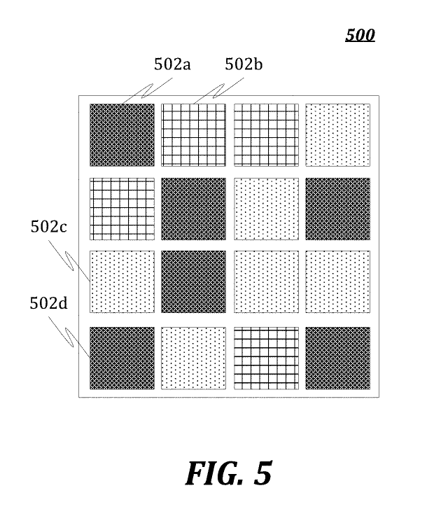

Further, the computer may include a stage 204 of assigning at least one classification to the at least one visual image based on at least one feature associated with the at least one visual image. In some embodiments, the transforming may include encoding the non-visual data into at least one region of the at least one visual image. In some embodiments, the at least one region may include a plurality of pixels. Further, as illustrated in FIG. 5, the at least one region may include a regular arrangement of pixels of predetermined dimensions.

In some embodiments, the non-visual data may include a plurality of variables and a plurality of values associated with the plurality of variables. For example, the non-visual data may include variable-value pairs such as Var1-VaI1, Var2-VaI2, Var3-VaI3 and Var4-VaI4. Further, the at least one visual image may include a plurality of regions, such as, for example, regions 502a-d. Further, each region may be associated with at least one variable of the plurality of variables. For instance, each region along the vertical axis may be assigned to a distinct variable. Accordingly, region 502c may be assigned to Var1, 502d may be assigned to Var2 and so on. Further, a region may be associated with a visual characteristic based on a value corresponding to the variable associated with the region. In some embodiments, the visual characteristic may be one or more of intensity, color and polarization. For instance, as shown in FIG. 5, the visual characteristic of region 502c is distinct from that of region 502d owing to difference in corresponding values.

In some embodiments, the visual characteristic may be according to at least one image encoding standard, such as for example, JPEG, TIFF, PNG, BMP etc. Accordingly, parameters such as bit length, dynamic range, etc. of the at least one image in the form of digital representation may be according to the specification of the at least one image encoding standard. In some embodiments, the visual characteristic may be according to at least one color model.

In some embodiments, the computer implemented method 200 may further include a stage of defining dimensions of the at least one visual image. Additionally, the computer implemented method 200 may include a stage of associating each region of the at least one visual image with the at least one variable of the plurality of variables. In some embodiments, the at least one color model may include one or more of RGB model, CMY model, HSI model and YIQ model.

In some embodiments, a plurality of regions of a visual image may be associated may be associated with a variable. Further, the plurality of values associated with the variable correspond to a plurality of time instants. Further, each of the plurality of regions of the visual image may be associated with a corresponding value of the plurality of values. For example, as illustrated in FIG. 5, regions spanning across the horizontal axis, such as regions 502a and 502b may correspond to values of a variable at a plurality of time instants. For example, region 502a may be associated with value of Var4 at a time instant T1, while region 502b may be associated with value of Var4 at a time instant T2.

In some embodiments, the computer implemented method 200 may further may include assigning a reference visual characteristic with a reference region of the plurality of regions. Further, the reference visual characteristic may be indicative of a periodic event. For example, as illustrated in FIG. 10, a weekly strip may be inserted among the at least one image in order to capture the weekly periodicity. In some embodiments, the periodic event corresponds to one or more of a time, a day, a week, a month and a year of a calendar.

In some embodiments, the non-visual data may be representative of at least one activity of a plurality of users of a telecommunications service. In some embodiments, the at least one classification may be representative of a likelihood of churn of a user from the telecommunications service. In other words, the at least one classification may include two classes, namely, Churn and Non-Churn.

In some embodiments, the non-visual data may include Call Detail Records (CDRs of a plurality of users of a telecommunications service. In some embodiments, the non-visual data may include a plurality of variables and a plurality of values corresponding to the plurality of variables. Further, the plurality of variables may be representative of the at least one activity. Further, the at least one activity may include out-going call activity, incoming call activity and top-up activity.

In some embodiments, the at least one visual image may include a plurality of regions. Further, a region may be associated with a variable of the plurality of variables. Further, the region may be associated with a visual characteristic based on a value corresponding to the variable associated with the region. In some embodiments, the visual characteristic may include brightness associated with the region. Further, the brightness may be proportional to an extent of an activity represented by the variable.

In some embodiments, the computer implemented method may further may include associating a saturation level corresponding to the variable associated with the top-up activity. Further, beyond the saturation level, the brightness may be independent of the extent of the activity.

In some embodiments, the visual characteristic may include a color associated with the region. Further, the brightness may include an intensity of the color.

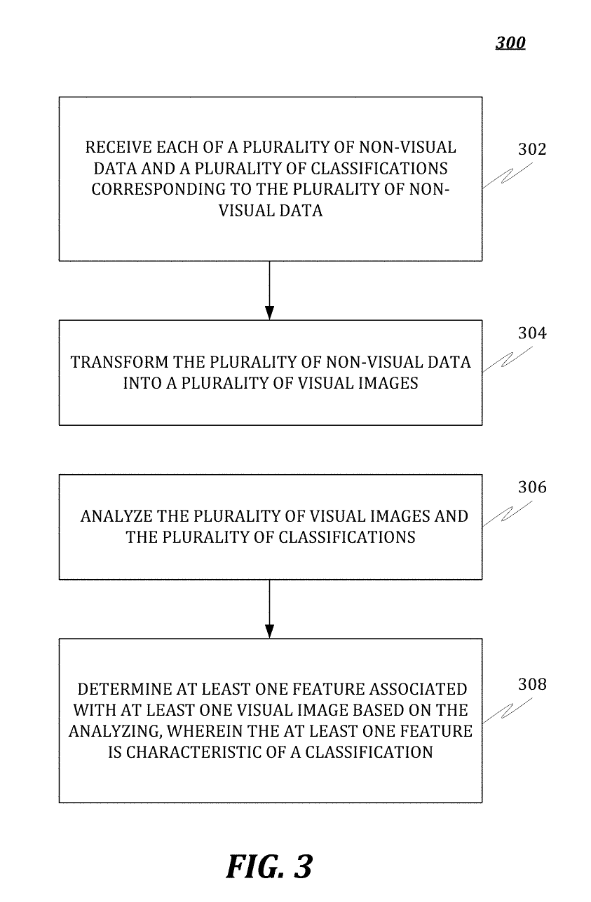

Further, the at least one feature, based on which the assigning of the at least one classification is performed, may be determined automatically using machine learning as exemplarily illustrated in FIG. 3.

Accordingly, the further disclosed is a computer implemented method 300 that may include a stage 302 of receiving each of a plurality of non-visual data and a plurality of classifications corresponding to the plurality of non-visual data. Further, each non-visual data of the plurality of non-visual data may be associated with at least one classification of the plurality of classifications. Furthermore, the computer implemented method 300 may include a stage 304 of transforming the plurality of non-visual data into a plurality of visual images. Additionally, the computer implemented method 300 may include a stage 306 of analyzing the plurality of visual images and the plurality of classifications. Further, the computer implemented method 300 may include a stage 308 of determining the at least one feature associated with the at least one visual image based on the analyzing. Further, the at least one feature may be characteristic of a classification of the at least one classification. In some embodiments, the analyzing may be performed by using machine learning. In some embodiments, the machine learning may be one or more of supervised learning and unsupervised learning. In some embodiments, the machine learning may include deep learning. In some embodiments, the machine learning may include training an artificial neural network based on the plurality of non-visual data and the plurality of classifications. In some embodiments, the machine learning may include training a convolutional neural network (ConvNet).

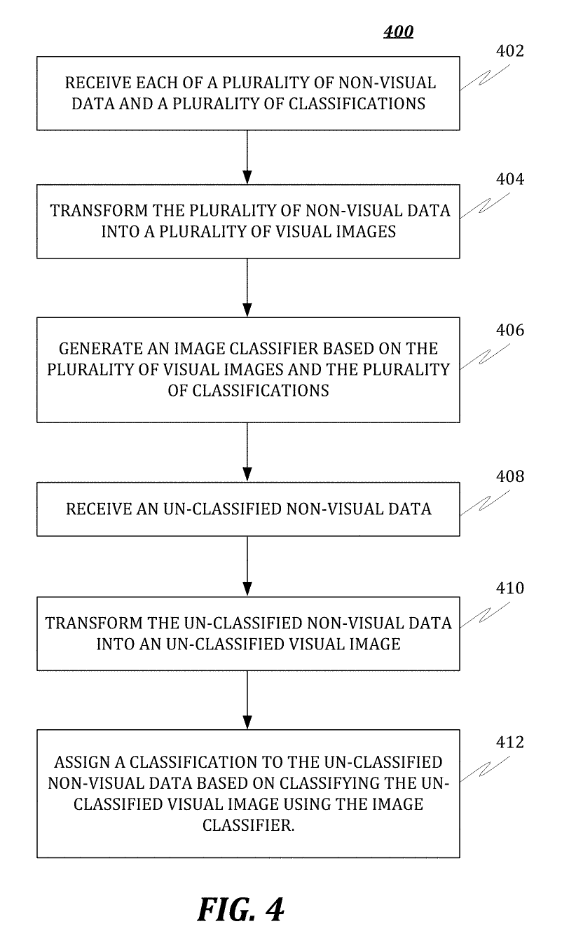

Further disclosed is a computer implemented method 400 of classifying non-visual data as illustrated in FIG. 4, in accordance with some embodiments. The computer implemented method 400 may include a stage 402 of receiving each of a plurality of non-visual data and a plurality of classifications corresponding to the plurality of non-visual data. Additionally, the computer implemented method 400 may include a stage 404 of transforming the plurality of non-visual data into a plurality of visual images. Further, the computer implemented method 400 may include a stage 406 of generating an image classifier based on the plurality of visual images and the plurality of classifications. Furthermore, the computer implemented method 400 may include a stage 408 of receiving an un-classified non-visual data. Additionally, the computer implemented method 400 may include a stage 410 of transforming the un-classified non-visual data into an un-classified visual image. Further, the computer implemented method 400 may include a stage 412 of assigning a classification to the un-classified non-visual data based on classifying the un-classified visual image using the image classifier.

Also disclosed herein, is a computer implemented method of facilitating classification of non-visual data. The computer implemented method may include a stage of receiving each of a plurality of non-visual data and a plurality of classifications corresponding to the plurality of non-visual data. Further, each non-visual data of the plurality of non-visual data may be associated with at least one classification of the plurality of classifications. Further, the computer implemented method may include a stage of transforming the plurality of non-visual data into a plurality of visual images. Furthermore, the computer implemented method may include a stage of analyzing the plurality of visual images and the plurality of classifications. Further, the computer implemented method may include a stage of determining at least one feature associated with a visual image of the at least one visual image based on the analyzing. Further, the at least one feature may be characteristic of a classification of the at least one classification.

In some embodiments, the computer implemented method may further may include a stage of receiving an un-classified non-visual data. Further, the computer implemented method may include a stage of transforming the un-classified non-visual data into an un-classified visual image. Furthermore, the computer implemented method may include a stage of determining the at least one feature associated with the un-classified visual image. Additionally, the computer implemented method may include a stage of assigning the classification to the un-classified non-visual data based on the determining.

### IV. Platform Architecture

The non-visual data classification system 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although methods 200, 300, 400, 600 and 900 have been described to be performed by a computing device 1400, it should be understood that, in some embodiments, different operations may be performed by different networked elements in operative communication with computing device 1400.

Embodiments of the present disclosure may comprise a system having a memory storage and a processing unit. The processing unit coupled to the memory storage, wherein the processing unit is configured to perform the stages of methods 200, 300, 400, 600 and 900.

FIG. 14 is a block diagram of a system including computing device 1400. Consistent with an embodiment of the disclosure, the aforementioned memory storage and processing unit may be implemented in a computing device, such as computing device 1400 of FIG. 14. Any suitable combination of hardware, software, or firmware may be used to implement the memory storage and processing unit. For example, the memory storage and processing unit may be implemented with computing device 1400 or any of other computing devices 1418, in combination with computing device 1400. The aforementioned system, device, and processors are examples and other systems, devices, and processors may comprise the aforementioned memory storage and processing unit, consistent with embodiments of the disclosure.

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400′s operation. In one embodiment, programming modules 1406 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and nonvolatile, removable and non-removable media implemented in any method or technology for storage of information, such as computer readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420) may perform processes including, for example, stages of one or more of methods 200, 300, 400, 600 and 900 as described above. The aforementioned process is an example, and processing unit 1402 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Aspects of the Disclosure

The follow aspects are described to identify the various embodiments of the present disclosure.
Aspect 1. A computer implemented method of classifying non-visual data, the computer implemented method comprising:
   transforming the non-visual data into at least one visual image; and
   assigning at least one classification to the at least one visual image based on at least one feature associated with the at least one visual image.
Aspect 2. The computer implemented method of aspect 1, wherein the non-visual data comprises a plurality of data elements, wherein integrity of the non-visual data is independent of a spatial arrangement of the plurality of data elements on a surface.
Aspect 3. The computer implemented method of aspect 1, wherein the non-visual data comprises a plurality of data elements, wherein integrity of the non-visual data is independent of a plurality of spatial relationships amongst the plurality of data elements.
Aspect 4. The computer implemented method of aspect 1, wherein the non-visual data comprises a plurality of data elements, wherein each of the plurality of data elements is not associated with a predetermined spatial location on a surface.
Aspect 5. The computer implemented method of aspect 1, wherein the non-visual data comprises a plurality of variables and a plurality of values corresponding to the plurality of variables, wherein each of the plurality of variables is independent of a characteristic of a travelling wave, wherein the characteristic of the travelling wave comprises at least one of an intensity, a frequency and a polarization.
Aspect 6. The computer implemented method of aspect 1, wherein the transforming comprises encoding the non-visual data into at least one region of the at least one visual image.
Aspect 7. The computer implemented method of aspect 6, wherein the at least one region comprises a plurality of pixels.
Aspect 8. The computer implemented method of aspect 1, wherein the non-visual data comprises a plurality of variables and a plurality of values associated with the plurality of variables, wherein the at least one visual image comprises a plurality of regions, wherein each region is associated with at least one variable of the plurality of variables, wherein a region is associated with a visual characteristic based on a value corresponding to the variable associated with the region.
Aspect 9. The computer implemented method of aspect 8, wherein the visual characteristic is at least one of intensity, color and polarization.
Aspect 10. The computer implemented method of aspect 8, wherein the visual characteristic is according to at least one image encoding standard.
Aspect 11. The computer implemented method of aspect 8, wherein the visual characteristic is according to at least one color model.
Aspect 12. The computer implemented method of aspect 8, further comprising:
   defining dimensions of the at least one visual image; and
   associating each region of the at least one visual image with the at least one variable of the plurality of variables.
Aspect 13. The computer implemented method of aspect 11, wherein the at least one color model comprises at least one of RGB model, CMY model, HSI model and YIQ model.
Aspect 14. The computer implemented method of aspect 8, wherein a plurality of regions of a visual image are associated is associated with a variable, wherein the plurality of values associated with the variable correspond to a plurality of time instants, wherein each of the plurality of regions of the visual image is associated with a corresponding value of the plurality of values.
Aspect 15. The computer implemented method of aspect 14 further comprising assigning a reference visual characteristic with a reference region of the plurality of regions, wherein the reference visual characteristic is indicative of a periodic event.
Aspect 16. The computer implemented method of aspect 15, wherein the periodic event corresponds to at least one of a time, a day, a week, a month and a year of a calendar.
Aspect 17. The computer implemented method of aspect 1, wherein the non-visual data is representative of at least one activity of a plurality of users of a telecommunications service.
Aspect 18. The computer implemented method of aspect 17, wherein the at least one classification is representative of a likelihood of churn of a user from the telecommunications service.
Aspect 19. The computer implemented method of aspect 1, wherein the non-visual data comprises Call Detail Records (CDRs) of a plurality of users of a telecommunications service.
Aspect 20. The computer implemented method of aspect 18, wherein the non-visual data comprises a plurality of variables and a plurality of values corresponding to the plurality of variables, wherein the plurality of variables is representative of the at least one activity, wherein the at least one activity comprises out-going call activity, incoming call activity and top-up activity.
Aspect 21. The computer implemented method of aspect 20, wherein the at least one visual image comprises a plurality of regions, wherein a region is associated with a variable of the plurality of variables, wherein the region is associated with a visual characteristic based on a value corresponding to the variable associated with the region.
Aspect 22. The computer implemented method of aspect 21, wherein the visual characteristic comprises brightness associated with the region, wherein the brightness is proportional to an extent of an activity represented by the variable.
Aspect 23. The computer implemented method of aspect 22 further comprising associating a saturation level corresponding to the variable associated with the top-up activity, wherein, beyond the saturation level, the brightness is independent of the extent of the activity.
Aspect 24. The computer implemented method of aspect 22, wherein the visual characteristic comprises a color associated with the region, wherein the brightness comprises an intensity of the color.
Aspect 25. The computer implemented method of aspect 1 further comprising:
   receiving each of a plurality of non-visual data and a plurality of classifications corresponding to the plurality of non-visual data, wherein each non-visual data of the plurality of non-visual data is associated with at least one classification of the plurality of classifications;
   transforming the plurality of non-visual data into a plurality of visual images;
   analyzing the plurality of visual images and the plurality of classifications; and
   determining the at least one feature associated with the at least one visual image based on the analyzing, wherein the at least one feature is characteristic of a classification of the at least one classification.
Aspect 26. The computer implemented method of aspect 25, wherein the analyzing is performed by using machine learning.
Aspect 27. The computer implemented method of aspect 14, wherein the machine learning is at least one of supervised learning and unsupervised learning.
Aspect 28. The computer implemented method of aspect 14, wherein the machine learning comprises deep learning.
Aspect 29. The computer implemented method of aspect 14, wherein the machine learning comprises training an artificial neural network based on the plurality of non-visual data and the plurality of classifications.
Aspect 30. The computer implemented method of aspect 29, wherein the machine learning comprises training a convolutional neural network (ConvNet).
Aspect 31. A computer implemented method of facilitating classification of non-visual data, the computer implemented method comprising:
   receiving each of a plurality of non-visual data and a plurality of classifications corresponding to the plurality of non-visual data, wherein each non-visual data of the plurality of non-visual data is associated with at least one classification of the plurality of classifications;
   transforming the plurality of non-visual data into a plurality of visual images;
   analyzing the plurality of visual images and the plurality of classifications; and
   determining at least one feature associated with a visual image of the at least one visual image based on the analyzing, wherein the at least one feature is characteristic of a classification of the at least one classification.
Aspect 32. The computer implemented method of aspect 31 further comprising
   receiving an un-classified non-visual data; and
   transforming the un-classified non-visual data into an un-classified visual image;
   determining the at least one feature associated with the un-classified visual image; and
   assigning the classification to the un-classified non-visual data based on the determining.
Aspect 33. A computer implemented method of classifying non-visual data, the computer implemented method comprising:
   receiving each of a plurality of non-visual data and a plurality of classifications corresponding to the plurality of non-visual data;
   transforming the plurality of non-visual data into a plurality of visual images;
   generating an image classifier based on the plurality of visual images and the plurality of classifications;
   receiving an un-classified non-visual data; and
   transforming the un-classified non-visual data into an un-classified visual image; and
   assigning a classification to the un-classified non-visual data based on classifying the un-classified visual image using the image classifier.

The following is claimed:

1. A computer implemented method of classifying non-visual data, the computer implemented method comprising:
transforming the non-visual data into at least one visual image; and
assigning at least one classification to the at least one visual image based on at least one feature associated with the at least one visual image.

2. The computer implemented method of claim 1, wherein the non-visual data comprises a plurality of data elements, wherein integrity of the non-visual data is independent of a spatial arrangement of the plurality of data elements on a surface.

3. The computer implemented method of claim 1, wherein the non-visual data comprises a plurality of data elements, wherein integrity of the non-visual data is independent of a plurality of spatial relationships amongst the plurality of data elements.

4. The computer implemented method of claim 1, wherein the non-visual data comprises a plurality of data elements, wherein each of the plurality of data elements is not associated with a predetermined spatial location on a surface.

5. The computer implemented method of claim 1, wherein the non-visual data comprises a plurality of variables and a plurality of values corresponding to the plurality of variables, wherein each of the plurality of variables is independent of a characteristic of a travelling wave, wherein the characteristic of the travelling wave comprises at least one of an intensity, a frequency and a polarization.

6. The computer implemented method of claim 1, wherein the transforming comprises encoding the non-visual data into at least one region of the at least one visual image.

7. The computer implemented method of claim 6, wherein the at least one region comprises a plurality of pixels.

8. The computer implemented method of claim 1, wherein the non-visual data comprises a plurality of variables and a plurality of values associated with the plurality of variables, wherein the at least one visual image comprises a plurality of regions, wherein each region is associated with at least one variable of the plurality of variables, wherein a region is associated with a visual characteristic based on a value corresponding to the variable associated with the region.

9. The computer implemented method of claim 8, wherein the visual characteristic is at least one of intensity, color and polarization.

10. The computer implemented method of claim 8, wherein the visual characteristic is according to at least one image encoding standard.

11. The computer implemented method of claim 8, wherein the visual characteristic is according to at least one color model.

12. The computer implemented method of claim 8, further comprising:
defining dimensions of the at least one visual image; and
associating each region of the at least one visual image with the at least one variable of the plurality of variables.

13. The computer implemented method of claim 11, wherein the at least one color model comprises at least one of RGB model, CMY model, HSI model and YIQ model.

14. The computer implemented method of claim 8, wherein a plurality of regions of a visual image are associated is associated with a variable, wherein the plurality of values associated with the variable correspond to a plurality of time instants, wherein each of the plurality of regions of the visual image is associated with a corresponding value of the plurality of values.

15. The computer implemented method of claim 14 further comprising assigning a reference visual characteristic with a reference region of the plurality of regions, wherein the reference visual characteristic is indicative of a periodic event.

16. The computer implemented method of claim 15, wherein the periodic event corresponds to at least one of a time, a day, a week, a month and a year of a calendar.

17. The computer implemented method of claim 1, wherein the non-visual data is representative of at least one activity of a plurality of users of a telecommunications service.

18. A computer implemented method of facilitating classification of non-visual data, the computer implemented method comprising:
receiving each of a plurality of non-visual data and a plurality of classifications corresponding to the plurality of non-visual data, wherein each non-visual data of the plurality of non-visual data is associated with at least one classification of the plurality of classifications;
transforming the plurality of non-visual data into a plurality of visual images;
analyzing the plurality of visual images and the plurality of classifications; and
determining at least one feature associated with a visual image of the at least one visual image based on the analyzing, wherein the at least one feature is characteristic of a classification of the at least one classification.

19. The computer implemented method of claim 31 further comprising
receiving an un-classified non-visual data; and
transforming the un-classified non-visual data into an un-classified visual image;
determining the at least one feature associated with the un-classified visual image; and
assigning the classification to the un-classified non-visual data based on the determining.

20. A computer implemented method of classifying non-visual data, the computer implemented method comprising:
receiving each of a plurality of non-visual data and a plurality of classifications corresponding to the plurality of non-visual data;
transforming the plurality of non-visual data into a plurality of visual images;
generating an image classifier based on the plurality of visual images and the plurality of classifications;
receiving an un-classified non-visual data; and
transforming the un-classified non-visual data into an un-classified visual image; and
assigning a classification to the un-classified non-visual data based on classifying the un-classified visual image using the image classifier.
